(19) United States
(12) Patent Application Publication
(10) Pub. No.: US 2025/0152460 A1
(43) Pub. Date: May 15, 2025

(54) Fascia gun with a retractable handle

(71) Applicants: Qiongyao Ao, Dongguan Guangdong (CN); Lihao Xia, Dongguan Guangdong (CN); Xiankui Qiu, Dongguan Guangdong (CN)

(72) Inventors: Qiongyao Ao, Dongguan Guangdong (CN); Lihao Xia, Dongguan Guangdong (CN); Xiankui Qiu, Dongguan Guangdong (CN)

(73) Assignee: Reestar International Limited, Kowloon (HK)

(21) Appl. No.: 18/831,219

(22) Filed: Sep. 26, 2024

(30) Foreign Application Priority Data
Nov. 13, 2023 (CN) 2023230488593

(51) Int. Cl. A61H 23/00; A61H 23/02

(52) U.S. Cl. CPC A61H 23/006; A61H 23/02; A61H 2201/0153; A61H 2201/1215; A61H 2201/1664; A61H 2201/5023

(57) ABSTRACT

The present invention discloses a fascia gun with a retractable handle, which relates to the technical field of massagers and comprises a body and a handle, wherein the handle comprises a handle housing, a handle sleeve rod, a battery cover and a handle connector, wherein the handle housing is sleeved outside the handle sleeve rod, and the outer diameter of the battery cover is larger than the inner diameter of the handle connector; a first protrusion is arranged on the outer surface of the handle sleeve rod, and the first protrusion comprises an integrally arranged middle arc surface and connecting arc surfaces connected to both sides of the middle arc surface; a first groove is arranged on the inner surface of the hand shell along its axial direction, and the shape and size of the first groove are the same as those of the first protrusion; when the first protrusion is located in the first groove, the handle sleeve rod is connected to the handle housing with a clearance fit, and when the first protrusion slides out of the first groove, the handle sleeve rod is connected to the handle housing with a tight fit; the invention adopts a simple structure to realize the telescopic and locking functions of the handle, which is convenient for massaging the back, waist and other parts.

### FIELD OF THE INVENTION

The invention relates to the technical field of massagers, specifically a fascia gun with a retractable handle.

### BACKGROUND OF THE INVENTION

The fascia gun is a machine used to relieve muscle fatigue, soreness or dredge meridians in the human body. It is mainly achieved by reciprocating the fascia head to impact the human body parts. Since the massage range of the fascia gun is relatively small, when you hold the fascia gun to massage yourself, some parts (such as the back, waist, etc.) are difficult to massage, so it is necessary to provide some fascia guns with retractable handles.

### BRIEF SUMMARY OF THE INVENTION

The invention discloses a fascia gun with a retractable handle to solve the technical problem that some parts are difficult to massage.

In order to solve the above technical problems, the invention proposes the following optimization technical solutions:

A fascia gun with a retractable handle, comprising a body and a handle, the handle comprising a handle housing, a handle sleeve rod, a battery cover and a handle connector, one end of the handle sleeve rod is connected to the body, the battery cover is assembled at the other end of the handle sleeve rod, the handle housing is a hollow structure, the handle connector is assembled at one end of the handle housing, the handle housing is sleeved outside the handle sleeve rod, and the outer diameter of the battery cover is greater than the inner diameter of the handle connector; The outer surface of the handle sleeve rod is provided with a first protrusion along its axial direction, the first protrusion. The handle comprises an integrally arranged middle cambered surface and connecting cambered surfaces connected to both sides of the middle cambered surface, the middle cambered surface is connected to the handle sleeve rod through the connecting cambered surfaces, and a connection angle between the connecting cambered surface and the handle sleeve rod is greater than a connection angle between the connecting cambered surface and the middle cambered surface; a first groove is provided on the inner surface of the handle housing along its axial direction, and the shape and size of the first groove are the same as those of the first protrusion; when the first protrusion is located in the first groove, the handle sleeve rod is loosely connected to the handle housing, and when the first protrusion slides out of the first groove, the handle sleeve rod is tightly connected to the handle housing.

Furthermore, the number of the first protrusions and the first grooves are both three, the three first protrusions are evenly distributed on the outer surface of the handle sleeve rod, and the three first grooves are evenly distributed on the inner surface of the handle housing.

Furthermore, a second groove is provided on the inner surface of the handle housing along the axial direction thereof, the depth of the second groove is smaller than the depth of the first groove, and the depth of the second groove is smaller than the height of the first protrusion.

Further, the handle also includes a handle middle shell, which is a hollow structure, and is located between the handle sleeve rod and the handle outer shell. Both ends of the handle middle shell are provided with middle shell end caps; The outer surface of the handle middle shell is provided with a second protrusion along its axial direction, and the shape and size of the second protrusion are the same as the first slot. When the second protrusion is located in the first slot, the handle middle shell is connected with the handle outer shell by clearance fit, and when the second protrusion slides out of the first slot, the handle middle shell is connected with the handle outer shell by tight fit; the inner surface of the handle middle shell is provided with a third slot along its axial direction, and when the first protrusion is located in the third slot, the handle middle shell is connected with the handle sleeve rod by clearance fit, and when the first protrusion slides out of the third slot, the handle middle shell is connected with the handle sleeve rod by tight fit; the tight fit between the handle outer shell and the hollow of the handle is greater than the tight fit between the handle middle shell and the handle sleeve rod.

Furthermore, an anti-slip layer is provided on the outer surface of the handle housing.

Furthermore, the body is provided with a massage head, a control component and a drive component are provided inside the body, a power supply component is provided in the hollow position of the handle sleeve rod, the power supply component is electrically connected to the control component and the drive component, the control component is electrically connected to the drive component, and the drive component is connected to the massage head and is used to drive the massage head to reciprocate.

Furthermore, the driving assembly includes a motor, an eccentric wheel and a connecting rod, the motor is electrically connected to the power supply assembly, the motor is fixed in the body, the eccentric wheel is connected to the output shaft of the motor, and the connecting rod connects the eccentric wheel and the massage head.

Furthermore, the control component includes a main control board, a digital tube and a display screen, and the main control board, the digital tube and the display screen are all electrically connected to the power supply component, the digital tube is electrically connected to the main control board, the display screen is electrically connected to the digital tube, and the main control board is electrically connected to the motor.

Furthermore, the body includes a first housing and a second housing, the first housing is connected to the handle, the second housing includes an upper cover and a lower cover, the upper cover is detachably connected to the lower cover, and the upper cover and the lower cover are both detachably connected to the first housing; the control component is arranged in the first housing, the driving component is arranged in the second housing, and the massage head passes through the second housing to connect to the connecting rod.

Furthermore, the first protrusion is in the shape of a rectangular protrusion, the first slot is in the shape of a rectangular slot, and a limiting portion is formed between the first slot and the inner wall of the handle housing.

The invention has the following beneficial effects compared with the prior art. The fascia gun with a retractable handle provided by the invention is provided with a handle housing and a handle sleeve rod, wherein the handle housing is provided with a first slot, and the handle sleeve rod is provided with a first protrusion. When the handle length needs to be adjusted, the handle housing is rotated so that the first slot on it covers. the first protrusion, and the handle housing can slide along its axial direction, thereby playing a role in adjusting the handle length. When the handle needs to be locked, the handle housing is rotated so that the first protrusion of the handle sleeve rod moves out of the first slot, and the first protrusion presses against the inner wall of the handle sleeve rod to play a locking role; the invention adopts a simple structure to realize the telescopic and locking functions of the handle, which is convenient for massaging the back, waist and other parts.

### BRIEF DESCRIPTION OF THE SEVERAL VIEWS OF THE DRAWINGS

FIG. 1 is a schematic diagram of the overall structure of the first embodiment of the invention;

FIG. 2 is an exploded view of the overall structure of the first embodiment of the invention;

FIG. 3 is a radial cross-sectional view of the handle of the first embodiment of the invention;

FIG. 4 is an enlarged view of the A point of FIG. 3;

FIG. 5 is a radial cross-sectional view of the handle of the fourth embodiment of the invention; and

FIG. 6 is an enlarged view of the B point of FIG. 5.

### DETAILED DESCRIPTION OF THE INVENTION

In order to make the purpose, technical solutions and advantages of the embodiments of this application clearer, the technical solutions in the embodiments of this application will be described clearly and completely in combination with the drawings in the embodiments of this application. Obviously, the described embodiments are part of the embodiments of this application, not all of them. Based on the embodiments in this application, all other embodiments obtained by ordinary technicians in this field without creative work are within the scope of protection of this application.

### Embodiment One

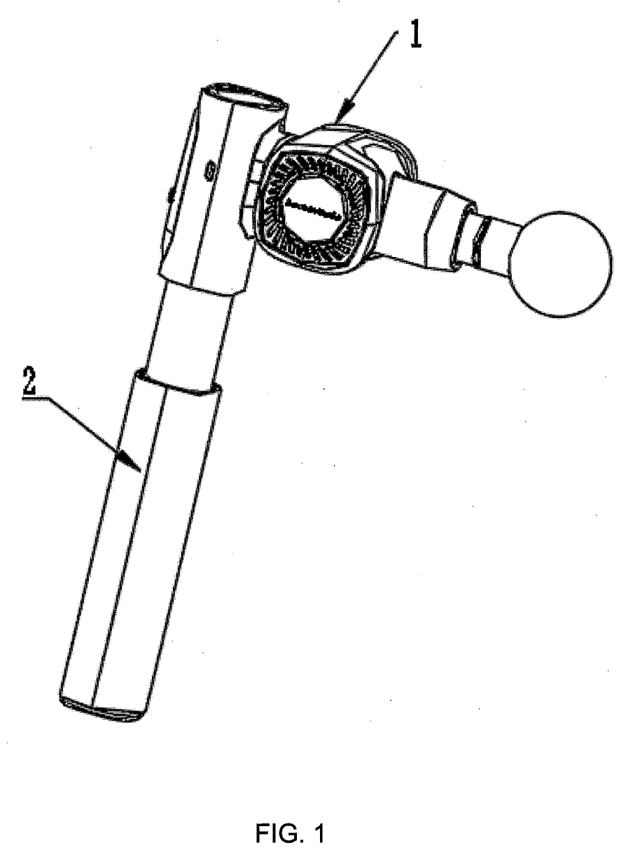

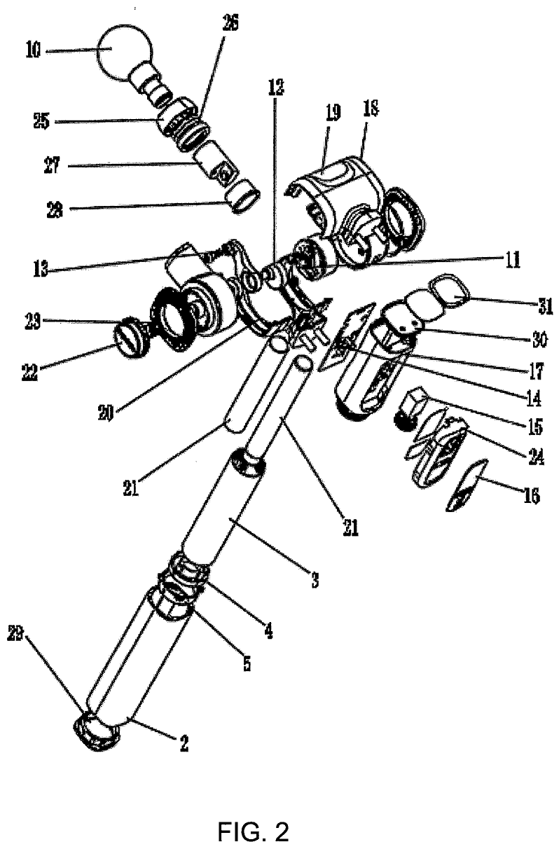

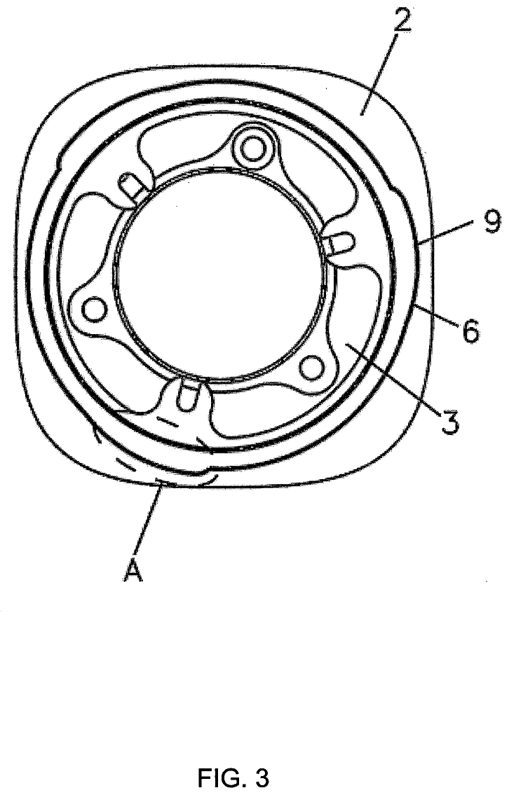

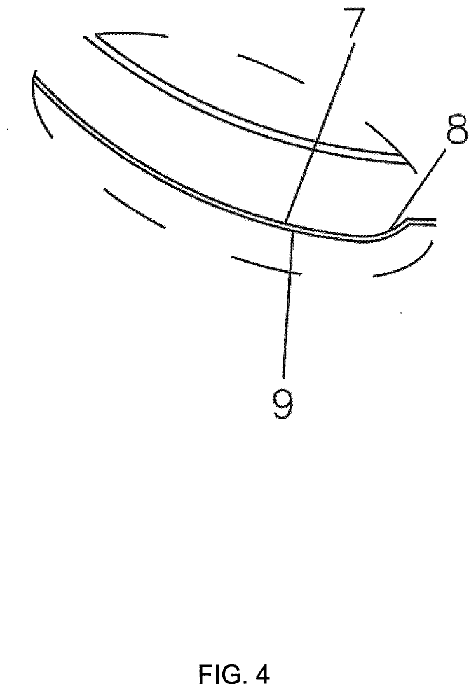

In FIGS. 1 to 4, a fascia gun with a retractable handle, comprising a body 1 and a handle, wherein the handle comprises a handle housing 2, a handle sleeve rod 3, a battery cover 4 and a handle connector 5, wherein one end of the handle sleeve rod 3 is connected to the body 1, and the battery cover 4 is mounted on the other end of the handle sleeve rod 3, the handle housing 2 is a hollow structure, the handle connector 5 is mounted on one end of the handle housing 2, the handle housing 2 is sleeved outside the handle sleeve rod 3, and the outer diameter of the battery cover 4 is greater than the inner diameter of the handle connector 5; specifically, the outer diameter of the battery cover 4 is greater than the inner diameter of the handle connector 5; The battery cover 4 is located in the handle housing 2, and because the outer diameter of the battery cover 4 is larger than the inner diameter of the handle connector 5, the battery cover 4 cannot pass through the handle connector 5 and is thus confined in the handle housing 2. An end cover 29 is provided at the end of the handle housing 2 away from the handle connector 5 to close the handle housing 2, thereby preventing the battery cover 4 from slipping out from this end.

It should be noted that the battery cover 4 is detachably connected to the handle sleeve rod 3 by means of screws or buckles, the handle connector 5 is detachably connected to the handle housing 2 by means of screws or buckles, and the end cover 29 is detachably connected to the handle housing 2 by means of screws or buckles. The first protrusion 6 and the handle sleeve rod 3 are both made of POM plastic and are wear-resistant.

The outer surface of the handle sleeve rod 3 is provided with a first protrusion 6 along its axial direction, and the first protrusion 6 includes an integrally arranged middle cambered surface 7 and connecting cambered surfaces 8 connected to both sides of the middle cambered surface 7, and the middle cambered surface 7 is connected to the handle sleeve rod 3 through the connecting cambered surfaces 8, and the connection angle between the connecting cambered surface 8 and the handle sleeve rod 3 is greater than the connection angle between the connecting cambered surface 8′ and the middle cambered surface 7; the inner surface of the handle housing 2 is provided with a first groove 9 along its axial direction, and the shape and size of the first groove 9 are the same as those of the first protrusion 6; when the first protrusion 6 is located in the first groove 9, the handle sleeve rod 3 is loosely connected to the handle housing 2, and when the first protrusion 6 slides out of the first groove 9, the handle sleeve rod 3 is tightly connected to the handle housing 2; by rotating the handle housing 2 to make the first protrusion 6 slide into or out of the first groove 9, the handle housing 2 and the handle sleeve rod 3 are slidably connected or locked, thereby adjusting the length of the handle, which is convenient for massaging the back, waist and other parts.

It should be noted that the connection angle between the connecting arc surface 8 and the handle sleeve rod 3 is greater than the connection angle between the connecting arc surface 8 and the middle arc surface 7, that is, the middle arc surface 7 is relatively flat, and the connecting arc surface 8 is steeper. When the first protrusion 6 is located in the first groove 9 and slides along the axial direction of the first groove 9, the connecting arc surface 8 can prevent the first protrusion 6 from sliding out of the first groove 9.

In this embodiment, the first protrusion 6 is an integral structure with the handle sleeve rod 3. In other embodiments, the first protrusion 6 can also be a solid spring or a soft body.

In this embodiment, the number of the first protrusions 6 and the first grooves 9 are both three, and the three first protrusions 6 are evenly distributed on the outer surface of the handle sleeve 3, and the three first grooves 9 are evenly distributed on the inner surface of the handle housing 2. The three groups of first protrusions 6 and first grooves 9 are provided to make the handle housing 2 more balanced when sliding relative to the handle sleeve 3.

In this embodiment, an anti-skid layer is provided on the outer surface of the handle housing 2, and the anti-skid layer plays an anti-skid role, making it easier to rotate the handle housing 2.

In this embodiment, the body 1 is provided with a massage head 10, a control component and a drive component are provided in the body 1, a power component 21 is provided in the hollow position of the handle sleeve rod 3, the power component 21 is electrically connected to the control component and the drive component, the control component is electrically connected to the drive component, the drive component is connected to the massage head 10 and is used to drive the massage head 10 to reciprocate, thereby massaging the human body. In addition, the power component 21 is specifically two batteries.

In this embodiment, the driving assembly includes a motor 11, an eccentric wheel 12 and a connecting rod 13, wherein the motor 11 is electrically connected to the power supply assembly 21, the motor 11 is fixed in the body 1, the eccentric wheel 12 is connected to the output shaft of the motor 11, and the connecting rod 13 connects the eccentric wheel 12 and the massage head 10; when the motor 11 is started, the eccentric wheel 12 drives the connecting rod 13 to move back and forth, thereby causing the massage head 10 to reciprocate back and forth.

In this embodiment, the control assembly includes a main control board 14, a digital tube 15 and a display screen 16. The main control board 14, the digital tube 15 and the display screen 16 are all electrically connected to the power supply assembly 21. The digital tube 15 is electrically connected to the main control board 14, and the display screen 16 is electrically connected to the digital tube 15. The main control board 14 is electrically connected to the motor 11. The digital tube 15 is used to display the grade of the motor 11, the battery power and other values. The display screen 16 is specifically embedded in the body 1 through a frame 24. In addition, the control assembly also includes a button 22, which is covered with a spring 23. The button 22 is connected to the switch of the motor 11 through the spring 23. Pressing the button 22 can start the motor 11. The spring 23 is used to reset the button 22.

In this embodiment, the body 1 includes a first housing 17 and a second housing 18, the first housing 17 is detachably connected to the handle and the second housing 18 by screws or buckles, the control component is arranged in the first housing 17, and the display screen 16 is embedded in the first housing 17 through a frame 24, the driving component is arranged in the second housing 18, the massage head 10 passes through the second housing 18 to connect the connecting rod 13, and the massage head 10 is connected to the connecting rod 13 through a front nozzle 25, a bearing sleeve 26, a push rod 27 and a bearing 28, the bearing 28 is sleeved on the connecting rod 13 and the push rod 27, the front nozzle 25 and the bearing sleeve 26 are an integral structure, the front nozzle 25 is sleeved on the massage head 10 and the push rod 27, and the push rod 27 is slidably connected to the second housing 18; when the motor 11 is started, the push rod 27 reciprocates relative to the second housing 18, thereby driving the massage head 10 to reciprocate. In addition, the control assembly further includes a shading plate 31 and a light guide 30. The light guide 30 is disposed in the first housing 17, and the shading plate 31 is used to seal the top of the first housing 17.

In this embodiment, the second housing 18 includes an upper cover 19 and a lower cover 20, and the upper cover 19 and the lower cover 20 are detachably connected by screws or buckles. The upper cover 19 and the lower cover 20 are detachably connected to the first housing 17 by screws or buckles.

### Embodiment Two

This embodiment is another implementation of the present application. The difference between this implementation and the implementation of Embodiment One is that: the inner surface of the handle housing 2 is also provided with a second slot along its axial direction. The second slot is smaller than the depth of the first slot 9, and the depth of the second slot is smaller than the height of the first protrusion 6, that is, when the first protrusion 6 rotates to the second slot, the handle housing 2 will also lock the handle sleeve rod 3, but the locking force at this time is smaller than the locking force of the first protrusion 6 Clamping the inner wall of the handle housing 2, so that the first protrusion 6 has two locking positions with different locking forces, which can be adjusted according to the actual locking requirements. In addition, the number of second slots is also three, and the three second slots are respectively connected to the three first slots 9, so that the first protrusion 6 can feel the locking force at this time when it rotates from the first slot 9 to the second slot, and then consider whether to rotate the first protrusion 6 to the inner wall of the handle housing 2.

### Embodiment Three

This embodiment is another implementation of the present application. The difference between this implementation and the implementation of Embodiment One is that: the handle further includes a handle middle shell, the handle middle shell is a hollow structure, the handle middle shell is located between the handle sleeve rod 3 and the handle outer shell 2, specifically, the handle middle shell is sleeved outside the handle sleeve rod 3, and the handle outer shell 2 is sleeved outside the handle middle shell, and both ends of the handle middle shell are provided with middle shell end covers, which are detachably connected to the handle middle shell by screws or buckles.

The outer surface of the handle middle shell is provided with a second protrusion along its axial direction, and the shape and size of the second protrusion are the same as those of the first slot 9. When the second protrusion is located in the first slot 9, the handle middle shell is connected with the handle outer shell 2 with a clearance fit, and when the second protrusion slides out of the first slot, the handle middle shell is tightly connected with the handle outer shell 2; the inner surface of the handle middle shell is provided with a third slot along its axial direction, and when the first protrusion 6 is located in the third slot, the handle middle shell is connected with the handle sleeve rod 3 with a clearance fit, and when the first protrusion 6 slides out of the third slot, the handle middle shell is tightly connected with the handle sleeve rod 3; the tight fit degree between the handle outer shell 2 and the handle hollow is greater than the tight fit degree between the handle middle shell and the handle sleeve rod 3; The inner walls of the shell and the handle housing 2 are often provided with limit strips. When the handle housing 2 is rotated, the handle middle shell rotates with the handle housing 2, that is, the handle middle shell and the handle housing 2 form a whole and rotate relative to the handle sleeve rod 3. The first protrusion 6 rotates to the third slot, and the handle housing 2 is slid up and down to make the handle middle shell and the handle housing 2 move up and down relative to the handle sleeve rod 3, which plays a role in preliminarily adjusting the handle length. At this time, the handle housing 2 continues to be rotated so that the handle sleeve rod is against the limit strip of the handle middle shell, and the handle middle shell no longer rotates relative to the handle sleeve rod 3. The handle housing 2 is rotated with greater force, and the handle housing 2 rotates relative to the handle middle shell, so that the second protrusion is located in the first slot 9, and the handle housing 2 is slid up and down to make the handle housing 2 move up and down relative to the handle middle shell and the handle sleeve rod 3, which plays a role in further adjusting the handle length.

### Embodiment Four

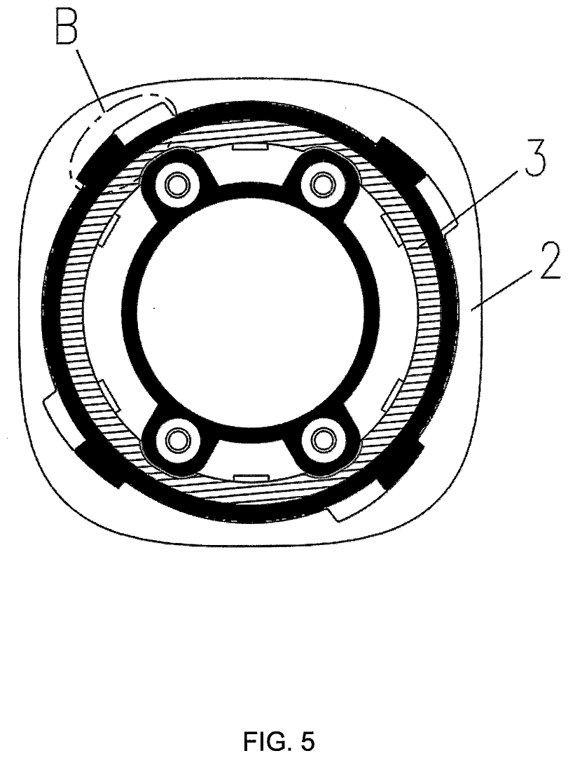

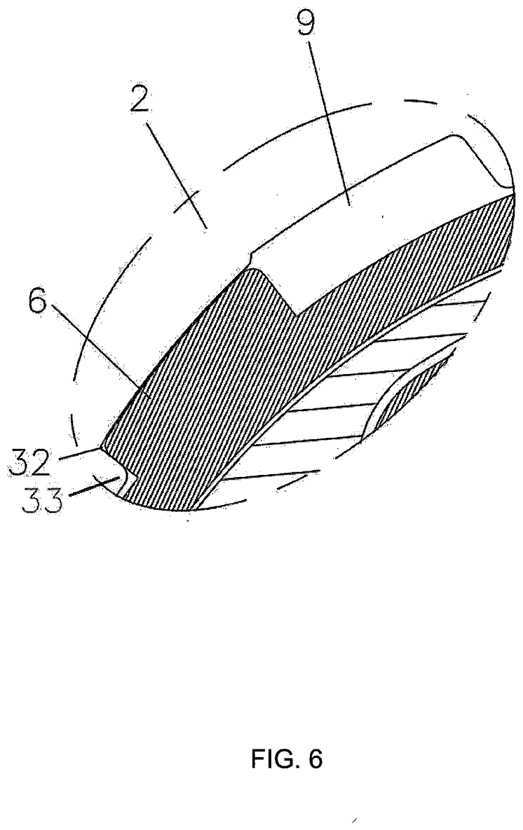

Referring to FIGS. 5 and 6, this embodiment is another implementation of the present application. The difference between this implementation and the implementation of Embodiment One is that: the first protrusion 6 is in the shape of a rectangular protrusion, the first slot 9 is in the shape of a rectangular slot, and a limiting portion 33 is formed between the first slot 9 and the inner wall of the handle housing 2; when the first protrusion 6 is ready to rotate in the first slot 9, the limiting portion 33 will limit the outer wall of the first protrusion 6 to prevent the first protrusion 6 from accidentally sliding out of the first slot 9. Only by manually rotating the handle housing 2 can the first protrusion 6 slide out of the first slot 9.

This embodiment also provides the same second slot 32 as that in the second embodiment, and thus can be adjusted according to actual locking requirements.

The above description is only a specific embodiment of the present invention, so that those skilled in the art can understand or implement the present invention. Various modifications to these embodiments will be obvious to those skilled in the art, and the general principles defined herein can be implemented in other embodiments without departing from the spirit or scope of the present invention. Therefore, the present invention will not be limited to the embodiments shown herein, but should conform to the widest scope consistent with the principles and novel features applied herein.

What is claimed is:

1. A fascia gun with a retractable handle, comprising a body and a handle, characterized in that the handle comprises
a handle housing having an inner surface and an outer surface
a handle sleeve rod having an outer surface,
a battery cover having an outer diameter and a handle connector having an inner diameter,
one end of the handle sleeve rod is connected to the body,
the battery cover is assembled at the other end of the handle sleeve rod,
the handle housing is a hollow structure,
the handle connector is assembled at one end of the handle housing,
the handle housing is sleeved outside the handle sleeve rod, and the outer diameter of the battery cover is greater than the inner diameter of the handle connector,
the outer surface of the handle sleeve rod is provided with a first protrusion along its axial direction, and the first protrusion includes an integrally arranged middle arc surface and connecting arc surfaces connected to both sides of the middle arc surface,
the middle arc surface is connected to the handle sleeve through the connecting arc surfaces, and the connection angle between the connecting arc surface and the handle sleeve is greater than the connection angle between the connecting arc surface and the middle arc surface,
the inner surface of the handle housing is provided with a first groove along the axial direction thereof, and the shape and size of the first groove are the same as the shape and size of the first protrusion,
when the first protrusion is located in the first groove, the handle sleeve rod is connected to the handle housing with a clearance fit, and when the first protrusion slides out of the first groove, the handle sleeve rod is tightly connected to the handle housing.

2. A fascia gun with a retractable handle according to claim 1, characterized in that the number of the first protrusions and the first grooves are both three, the three first protrusions are evenly distributed on the outer surface of the handle sleeve, and the three first grooves are evenly distributed on the inner surface of the handle housing.

3. A fascia gun with a retractable handle according to claim 1, characterized in that the inner surface of the handle housing is further provided with a second groove along its axial direction, the depth of the second groove is smaller than the depth of the first groove, and the depth of the second groove is smaller than the height of the first protrusion.

4. A fascia gun with a retractable handle according to claim 1, characterized in that
the handle further comprises
a handle middle shell and a handle outer shell,
the handle middle shell is a hollow structure having an outer surface and an inner surface,
the handle middle shell is located between the handle sleeve rod and the handle outer shell,
both ends of the handle middle shell are provided with a middle shell end cap,
the outer surface of the handle middle shell is provided with a second protrusion along its axial direction,
the shape and size of the second protrusion are the same as the first slot,
when the second protrusion is located in the first slot, the handle middle shell is connected with the handle outer shell with a clearance fit,
when the second protrusion slides out of the first slot, the handle middle shell is connected with the handle outer shell with a tight fit,
the inner surface of the handle middle shell is provided with a third slot along its axial direction,
when the first protrusion is located in the third slot, the handle middle shell is connected with the handle sleeve rod with a clearance fit,
when the first protrusion slides out of the third slot, the handle middle shell is connected with the handle sleeve rod with a tight fit,
the tight fit between the handle outer shell and the hollow of the handle is greater than the tight fit between the handle middle shell and the handle sleeve rod.

5. The fascia gun with a retractable handle according to claim 1, characterized in that an outer surface of the handle housing is provided with an anti-slip layer.

6. A fascia gun with a retractable handle according to claim 1, characterized in that the body is provided with a massage head, a control component and a driving assembly are provided in the body, a power supply assembly is provided in the hollow position of the handle sleeve, the power supply component is electrically connected to the control component and the drive component, the control component is electrically connected to the drive component, and the drive component is connected to the massage head and is used to drive the massage head to reciprocate.

7. A fascia gun with a retractable handle according to claim 6, characterized in that the driving assembly includes a motor, an eccentric wheel and a connecting rod, the motor is electrically connected to the power supply assembly, the motor is fixed in the body, the eccentric wheel is connected to the output shaft of the motor, and the connecting rod connects the eccentric wheel and the massage head.

8. A fascia gun with a retractable handle according to claim 7, characterized in that the control component includes a main control board, a digital tube and a display screen, the main control board, the digital tube and the display screen are all electrically connected to the power supply component, the digital tube is electrically connected to the main control board, the display screen is electrically connected to the digital tube, and the main control board is electrically connected to the motor.

9. A fascia gun with a retractable handle according to claim 7, characterized in that
the body comprises
a first housing and a second housing,
the first housing is connected to the handle,
the second housing includes an upper cover and a lower cover,
the upper cover is detachably connected to the lower cover, and both the upper cover and the lower cover are detachably connected to the first housing,
the control component is arranged in the first housing,
the driving component is arranged in the second housing, and the massage head passes through the second housing to connect to the connecting rod.

10. A fascia gun with a retractable handle according to claim 1, characterized in that the first protrusion is in the shape of a rectangular protrusion, the first groove is in the shape of a rectangular groove, and a limiting portion is formed between the first groove and the inner wall of the handle housing.
